(19) United States
(12) Patent Application Publication
(10) Pub. No.: US 2026/0213434 A1
(43) Pub. Date: Jul. 23, 2026

(54) IMPROVED BATTERY CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU-KE CHEN, Zhengzhou (CN); YING-LI YAN, Zhengzhou (CN)

(21) Appl. No.: 19/451,386

(22) Filed: Jan. 16, 2026

(30) Foreign Application Priority Data
Jan. 17, 2025 (CN) 202520120542.6

(51) Int. Cl. H01R 4/48

(52) U.S. Cl. CPC H01R 4/48

(57) ABSTRACT

A battery connector includes an insulating base having a bottom wall, a surrounding wall and a receiving groove; a negative terminal fixed in the bottom wall and including a first elastic arm with a first contacting portion; a positive terminal having a second elastic arm and a stopping portion, the second elastic arm having a second contacting portion for contacting with a side face of the button cell and two latching portions bending from two sides thereof respectively . The stopping portion is located in a same vertical plane with two distal ends extending out of the receiving groove and abutting against an outer side of the surrounding wall and a middle portion between the two distal ends is located at an inner side of the surrounding wall, and a lower edge of the middle portion is integrally connected with the second elastic arm by an inclined portion.

### BACKGROUND OF THE INVENTION

### Field of the Invention

The present invention relates to a battery connector.

### Description of Related Arts

China Patent No. 210723132U discloses a battery connector designed for connecting a button cell. The battery connector includes an insulating base, a negative terminal, and a positive terminal. The insulating base includes a bottom wall and a surrounding wall extending upward from the bottom wall. The surrounding wall together with the bottom wall forms a receiving groove for accommodating the button cell. The negative terminal is fixed to the bottom wall and has a first elastic arm designed to press against the bottom face of the button cell. The positive terminal includes a second elastic arm having a contacting portion for pressing against a side face of the button cell and two stopping portions. Each stopping portion is formed by bending from a corresponding side of the second elastic arm and is higher than the contacting portion. The stopping portion abuts against an outside face of the side wall. A guiding portion is formed by bending from an upper edge of the second elastic arm and a lower edge thereof is lower than an upper edge of the stopping portion. The button cell may be assembled into the receiving groove smoothly but with less assembling force. However, as the battery connector is small, it is hard to form the stopping portion by bending within a smaller tolerance range.

Therefore, it is desired to provide an improved battery connector.

### SUMMARY OF THE INVENTION

An object of the present invention is to provide an improved battery connector.

To achieve the above object, a battery connector comprises: an insulating base having a bottom wall, a surrounding wall extending upward from the bottom wall, and a receiving groove formed by the bottom wall and the surrounding wall for receiving a button cell; a negative terminal fixed in the bottom wall and comprising a first elastic arm with a first contacting portion extending upward into the receiving groove; a positive terminal having a second elastic arm and a stopping portion, the second elastic arm having a second contacting portion for contacting with a side face of the button cell and two latching portions bending from two sides thereof respectively and protruding into the receiving groove, wherein the stopping portion is located in a same vertical plane with two distal ends extending out of the receiving groove and abutting against an outer side of the surrounding wall and a middle portion between the two distal ends is located at an inner side of the surrounding wall, and a lower edge of the middle portion of the stopping portion is integrally connected with the second elastic arm by an inclined portion.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a battery connector covered with a protective cap of a first embodiment of this invention;

FIG. 2 is another perspective view of the battery connector and the protective cap in FIG. 1;

FIG. 3 is a perspective view of the battery connector and the protective cap, wherein the protective cap is separated from the battery connector;

FIG. 4 is an exploded perspective view of the battery connector in FIG. 1;

FIG. 5 is a perspective view of a positive terminal in FIG. 4;

FIG. 6 is another exploded perspective view of the battery connector in FIG. 4;

FIG. 7 is a perspective view of the battery connector in a second embodiment;

FIG. 8 is a perspective view of the positive terminal in FIG. 7;

FIG. 9 is a perspective view of the battery connector in a third embodiment;

FIG. 10 is an exploded perspective view of the battery connector in FIG. 9; and

FIG. 11 is a perspective view of the positive terminal and a negative terminal of the connector in FIG. 9.

### DETAILED DESCRIPTION OF THE PREFERRED EMBODIMENT

Reference will now be made in detail to the preferred embodiments of the present invention.

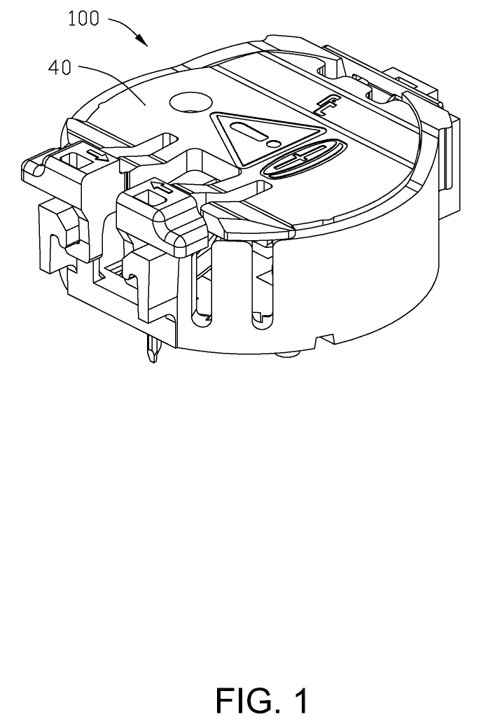

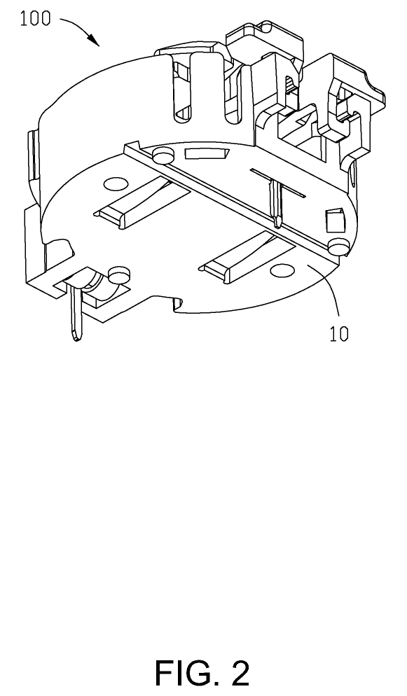

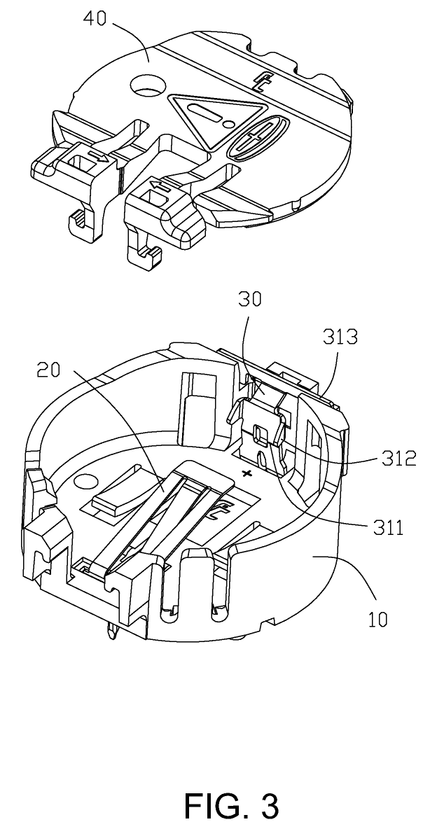

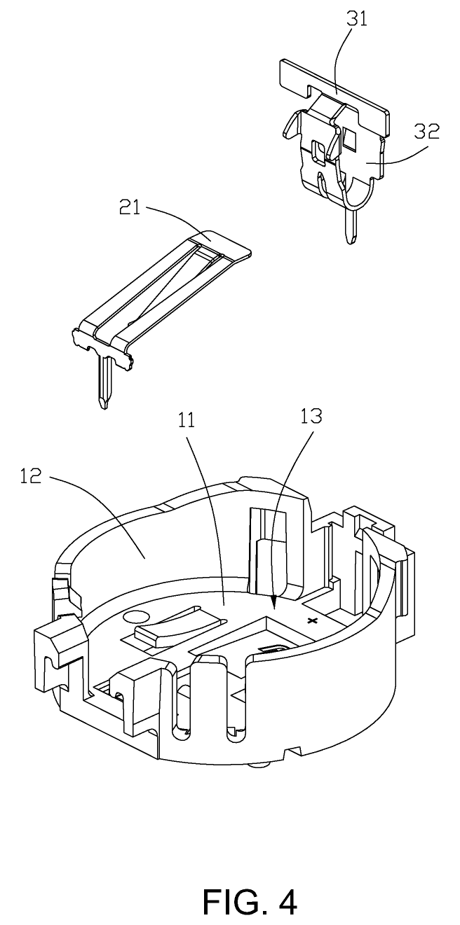

Referring to FIGS. 1-6, a battery connector 100 of a first embodiment to be installed on a circuit board is illustrated. A protective cap 40 is placed on the battery connector 100 to prevent damage to positive and negative terminals caused by dust or improper insertion of other conductive elements when a button cell is not inserted.

The battery connector 100 includes an insulating base 10, a negative terminal 20 and a positive terminal 30. The insulating base 10 includes a bottom wall 11, a surrounding wall 12 extending upward from the bottom wall 11, and a receiving groove 13 formed by the surrounding wall 12 and the bottom wall 11. The receiving groove 13 is used to accommodate a button cell (not shown). The negative terminal 20 is disposed on the bottom wall 11 and has a first contacting portion 21 protruding upward into the battery groove 13. The positive terminal 30 includes a second elastic arm 31 and a stopping portion 313. The second elastic arm 31 comprises a second contacting portion 311 for abutting against a side face of the button cell, and two latching portions 312 bent from each side of the second elastic arm 31 and protruding into the receiving groove 13. The stopping portion 313 is located in a same vertical plane with its two distal ends extending out of the receiving groove 13 and abutting against an outside face of the surrounding wall 12 while a middle portion between the two distal ends located at an inner side of the surrounding wall 12. A lower edge of the middle portion of the stopping portion 313 is integrally connected to the second elastic arm 31 via an inclined portion 314. In the invention, as the stopping portion 313 is a vertical plate and is connected to the second elastic arm via the inclined portion 314, an accurate tolerance fit is achieved between the stopping portion 313 and the surrounding wall 12 through simpler manufacturing process.

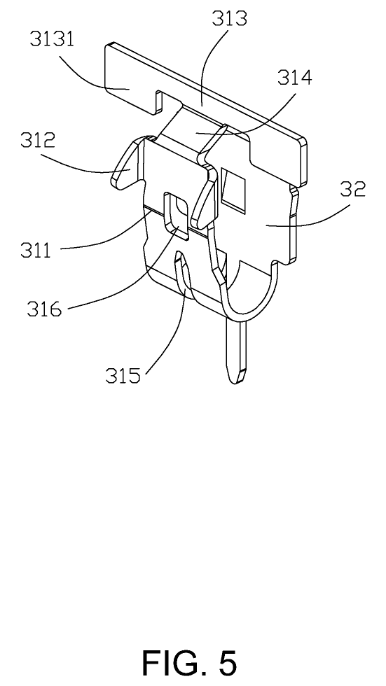

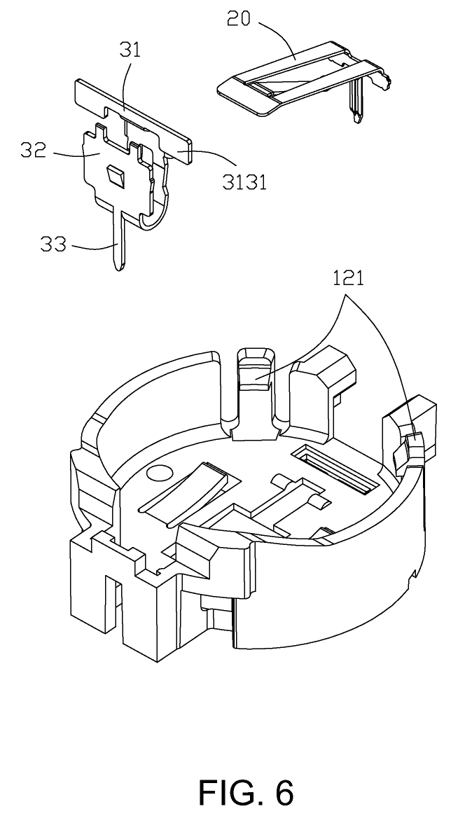

Referring FIGS. 5-6, the positive terminal 30 comprises a fixing portion 32 retained in the surrounding wall 12 and a welding leg 33 extending downward from the fixing portion 32. The welding leg 33 is torn from the second elastic arm 31, leaving the second elastic arm 31 an elongated opening 315 which penetrating an inner face and outer face of the second elastic arm 31.

The second elastic arm 31 bends and extends upward from a lower edge of the fixing portion 32 and form a U shape together with the fixing portion 32. The second elastic arm 31 is slightly folded to form a V-shaped and inwardly protruding second contacting portion 311 at an inner face thereof away from the fixing portion 32. The two latching portions 312 bend from the left side edge and right side edge of the second elastic arm 31 respectively, and the latching portions 312 are higher than the second contacting portion 311. The inclined portion 314 is higher than the latching portion 312 and thinner than the second elastic arm 31. Both two distal ends of the stopping portion 313 extend downward and form an additional portion 3131 respectively. Each additional portion 3131 is spaced apart from the inclined portion 314 and a lower edge thereof is higher than or flush with a lower edge of the inclined portion 314. The second elastic arm 31 is provided with a square opening 316 that penetrates the inner face and the outer face thereof. The square opening 316 goes across the second contacting portion 311 in an upper and lower direction. Furthermore, the surrounding wall 12 is cut out and form two elastic beams 121 opposite to the positive terminal 30. The upper end of each elastic beam 121 is provided with a retaining head protruding into the receiving groove 13.

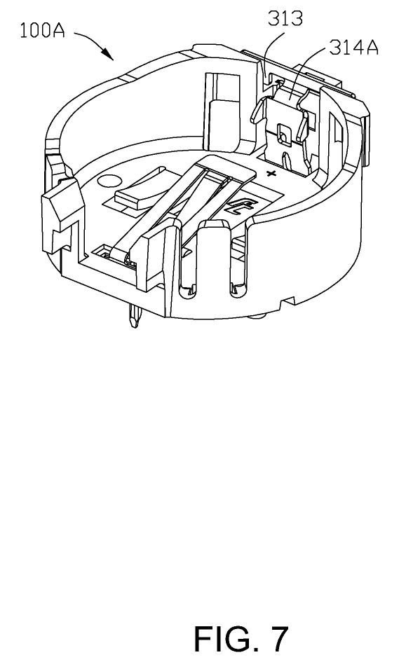

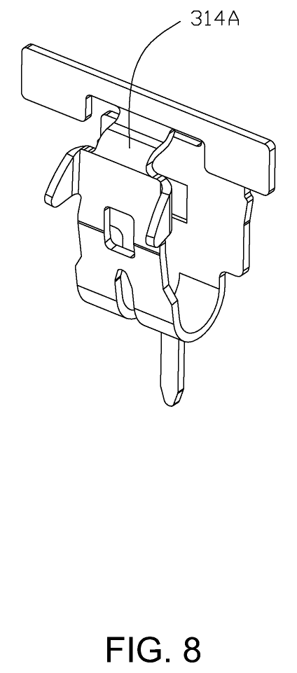

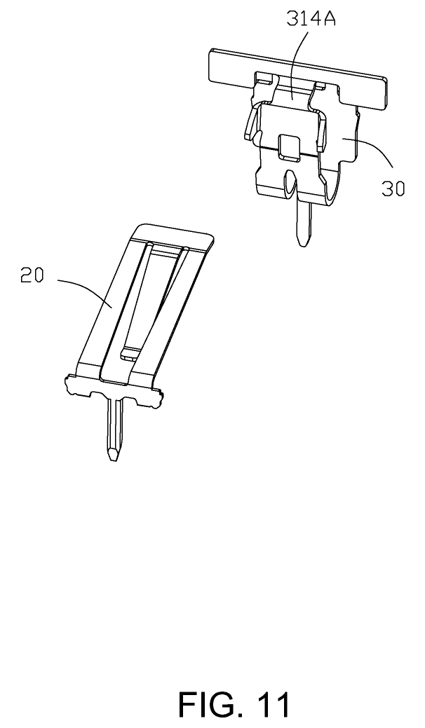

Referring to FIGS. 7-8 and FIG. 11, the battery connector 100A of a second embodiment is illustrated. Compared to the battery connector 100 in the first embodiment, the inclined portion 314A is warped. Preferably, the inclined portion 314A recesses downward from the lower edge of the stopping portion 313 first, and then connects an upper edge of the second elastic arm 31 by bulging out with rounded guiding chamfer, facilitating the insertion and removal of the button cell.

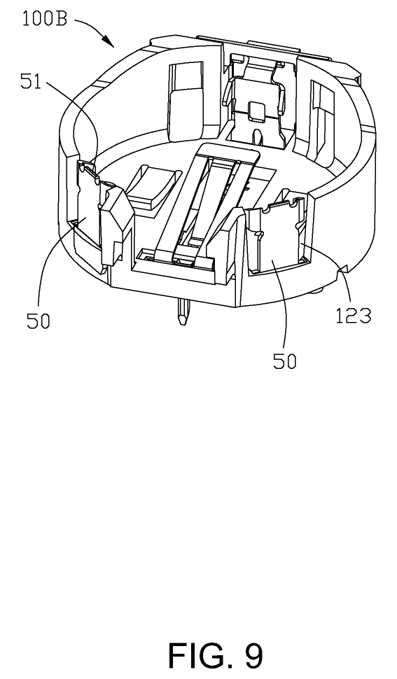

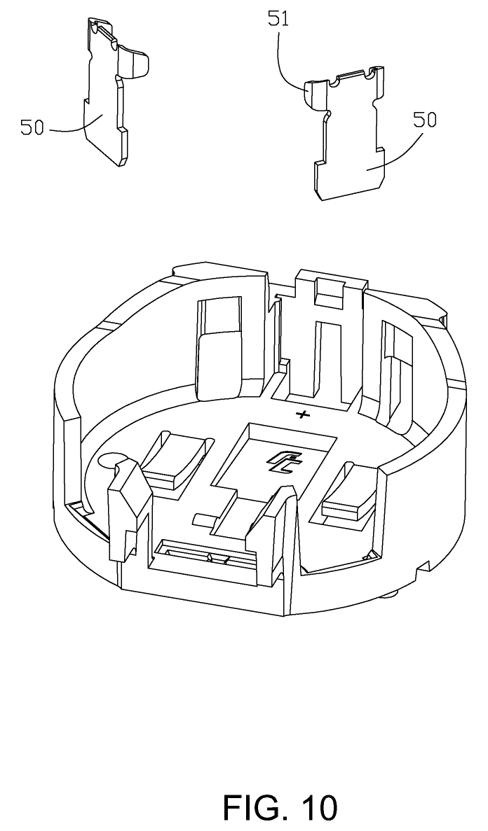

Referring to FIGS. 9-10, the battery connector 100B of the third embodiment is illustrated. The surrounding wall 12 is cut out and form two openings 123 facing the positive terminal 30. A metal elastic clip 50 is inserted in each opening 123 with two latching portions 51 protruding into the receiving groove 13 at an upper end thereof. In other words, the insulating elastic beam 121 of the surrounding wall 12 is replaced by the metal elastic clip 50 with higher strength and better elastic deformability, thereby facilitating the retention of button cells of different sizes. During an insertion of the button cell, the metal elastic clip 50 deforms as the button cell is inserted to minimize the impact force of the insulating base 10, thereby improving the overall adaptability and service life of the battery connector 100B.

As shown in FIGS. 1-3, in the embodiment, the protective cap 40 is locked to the insulating base 10. Preferably, the insulating housing 10 is provided with a pair of locking portions that are spaced apart from each other. The protective cap 40 has a pair of locking arms, and each locking arm has a hook extending downward and is latched with the corresponding locking portion. Each locking arm has a press portion rising from an upper face thereof, and the press portions are labeled with arrows. The locking arms drive the hooks to disengage from corresponding locking portion when the press portions are pressed along the arrows, thus the protective cover is able to be removed from the insulating base 10.

Although the present invention has been described with reference to particular embodiments, it is not to be construed as being limited thereto. Various alterations and modifications can be made to the embodiments without in any way departing from the scope or spirit of the present invention as defined in the appended claims.

1. A battery connector comprising:an insulating base having a bottom wall, a surrounding wall extending upward from the bottom wall, and a receiving groove formed by the bottom wall and the surrounding wall for receiving a button cell;a negative terminal fixed in the bottom wall and comprising a first elastic arm with a first contacting portion extending upward into the receiving groove;a positive terminal having a second elastic arm and a stopping portion, the second elastic arm having a second contacting portion for contacting with a side face of the button cell and two latching portions bending from two sides thereof respectively and protruding into the receiving groove;wherein the stopping portion is located in a same vertical plane with two distal ends extending out of the receiving groove and abutting against an outer side of the surrounding wall and a middle portion between the two distal ends is located at an inner side of the surrounding wall, and a lower edge of the middle portion of the stopping portion is integrally connected with the second elastic arm by an inclined portion.

2. The battery connector as claimed in claim 1, wherein the positive terminal comprises a fixing portion retained in the surrounding wall, and the second elastic arm bends upward from a lower edge of the fixing portion to form a U-shape together with the fixing portion.

3. The battery connector as claimed in claim 2, wherein the second elastic arm is folded to form the second contacting portion at an inner face thereof away from the fixing portion, the second contacting portion is V-shaped and inwardly protrudes, and the latching portions are leveled higher than the second contacting portion and the inclined portion is leveled higher than the latching portions.

4. The battery connector as claimed in claim 1, wherein each distal end of the stopping portion extends downward and forms an additional portion spaced apart from the inclined portion, and a lower edge of the additional portion is higher than or flush with a lower edge of the inclined portion.

5. The battery connector as claimed in claim 2, wherein the positive terminal comprises a welding leg extending downward from the fixing portion, and the welding leg is torn from the second elastic arm to form an elongated opening.

6. The battery connector as claimed in claim 5, wherein the second elastic arm is provided with a square opening penetrating an inner face and an outer face thereof, and the square opening goes across the second contacting portion in an upper and lower direction.

7. The battery connector as claimed in claim 1, wherein the surrounding wall is cut out to form two elastic beams opposite to the positive terminal, and each elastic beam is provided with a latching head at an upper end thereof.

8. The battery connector as claimed in claim 1, further comprising a metal elastic clip, and wherein the surrounding wall is cut out and form two openings facing the positive terminal, and the metal elastic clip is inserted in each opening with two latching portions thereof protruding into the receiving groove at an upper end thereof.

9. The battery connector as claimed in claim 1, further comprising a protective cover locked to the insulating base by a pair of locking portions and a pair of locking arms with hooks.

10. The battery connector as claimed in claim 1, wherein the inclined portion is warped.

11. A battery connector comprising:an insulating base comprising a bottom wall, a surrounding wall extending upward from the bottom wall, and a receiving groove formed by the bottom wall and the surrounding wall for receiving a button cell;a negative terminal fixed in the bottom wall and comprising a first elastic arm with a first contacting portion extending upward into the receiving groove;an integral positive terminal, comprising a fixing portion retained in the surrounding wall, a second elastic arm having a second contacting portion for contacting with a side face of the button cell, and a stopping portion connected to an upper edge of the second elastic arm;wherein the second elastic arm bends from the fixing portion upwardly and forms a U-shape together with the fixing portion, the stopping portion is in a vertical plane and is located over an opening of the U-shape, and an inner face of two distal ends of the stopping portion away from the fixing portion abuts against the surrounding wall.

12. The battery connector as claimed in claim 11, wherein the second elastic arm is connected to a middle portion of the stopping portion between the two distal ends by an inclined portion, and the inclined portion is thinner than the second elastic arm.
